(19) United States
(12) Patent Application Publication
(10) Pub. No.: US 2012/0005681 A1
(43) Pub. Date: Jan. 5, 2012

(54) ASSERTIONS-BASED OPTIMIZATIONS OF HARDWARE DESCRIPTION LANGUAGE COMPILATIONS

(76) Inventor: Subodh Moolamalla Reddy, San Jose, CA (US)

(21) Appl. No.: 12/827,607

(22) Filed: Jun. 30, 2010

(51) Int. Cl. G06F 9/46

(52) U.S. Cl. 718/102

(57) ABSTRACT

Methods and systems for assertion-based simulations of hardware description language are provided. A method may include reading hardware description models of one or more hardware circuits. The hardware description language models may be transformed into a program of instructions configured to, when executed by a processor: (a) assume assertions regarding the hardware description language models are true; (b) establish dependencies among processes of the program of instructions based on the assertions; and (c) dynamically schedule execution of the processes based on the established dependencies.

### TECHNICAL FIELD

This disclosure relates in general to hardware description languages and more particularly to a method and system for improving performance of hardware description language-based simulations.

### BACKGROUND

A hardware description language (HDL) is any language from a class of computer languages and/or programming languages for formal description of electronic circuits, and more specifically, digital logic. It can describe the circuit's operation, its design and organization, and tests to verify its operation by means of simulation. Typically, HDLs are standard text-based expressions of the spatial and temporal structure and behavior of electronic systems. HDLs are used to write executable specifications of some item of hardware. A simulation program, designed to implement the underlying semantics of the language statements and simulate the progress of time, provides the hardware designer with the ability to model a piece of hardware before it is created physically.

As complexity of hardware increases, so too does the complexity of hardware descriptions and the computing resources necessary to simulate the hardware description. Thus, simulations may consume considerable time, and any performance improvement may directly translate into improved productivity of hardware circuit designers.

To reduce verification complexity, designers are increasingly turning to assertion-based verification (ABV). An assertion is a factual statement about an expected or assumed behavior of an object under test. Such assertions do not model circuit activity, but capture and document the “designer's intent” in the HDL code.

### SUMMARY OF THE DISCLOSURE

The present disclosure discloses methods and systems for improving performance of hardware description language-based simulations that substantially eliminate or reduce at least some of the disadvantages and problems associated with existing methods and systems.

A method may include reading hardware description models of one or more hardware circuits. The hardware description language models may be transformed into a program of instructions configured to, when executed by a processor: (a) assume assertions regarding the hardware description language models are true; (b) establish dependencies among processes of the program of instructions based on the assertions; and (c) dynamically schedule execution of the processes based on the established dependencies.

Technical advantages of certain embodiments of the present disclosure include providing for HDL simulation process scheduling that may improve performance of HDL simulation.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a block diagram of an example computing device, in accordance with certain embodiments of the present disclosure;

FIG. 2 illustrates a flow chart of an example event-driven hardware description language simulation flow, in accordance with certain embodiments of the present disclosure;

FIG. 3 illustrates a block diagram of processes modeled by a hardware description language and a process schedule based on relationships among the processes, in accordance with certain embodiments of the present disclosure;

FIG. 4 illustrates a block diagram of processes modeled by a hardware description language and a process schedule based on relationships among the processes and created using assertions-based scheduling, in accordance with certain embodiments of the present disclosure; and

FIG. 5 illustrates a flow chart of an example method for process scheduling using assertions-based scheduling, in accordance with certain embodiments of the present disclosure.

### DETAILED DESCRIPTION OF THE INVENTION

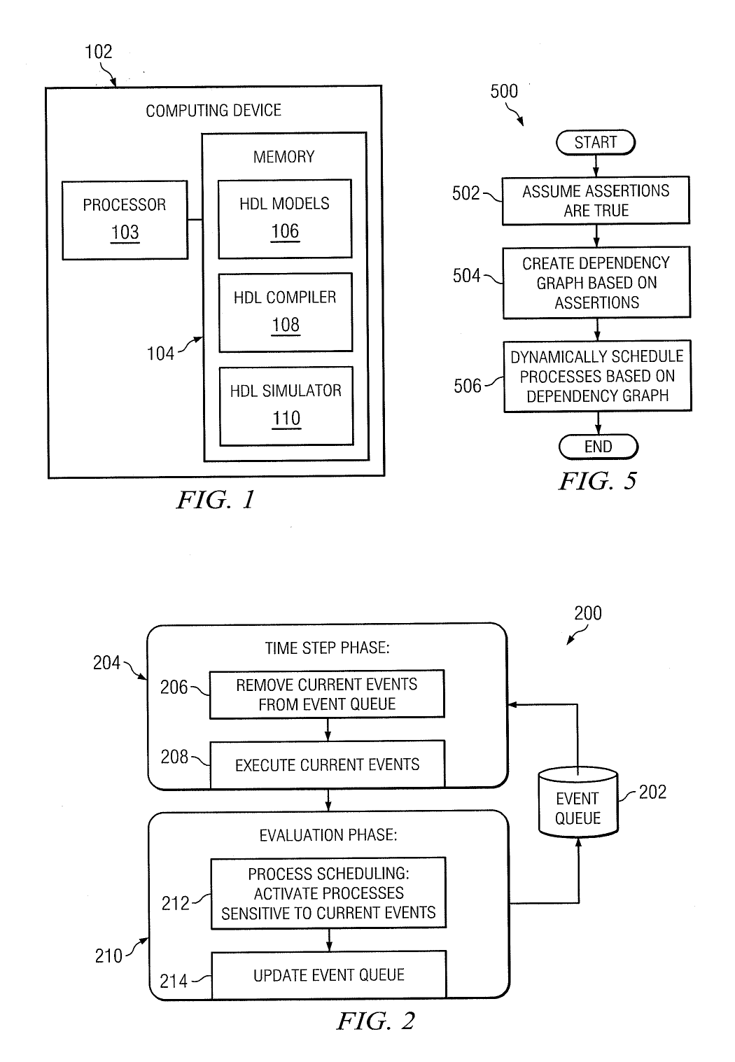

Embodiments and their advantages are best understood by reference to FIGS. 1-5, wherein like numbers are used to indicate like and corresponding parts.

FIG. 1 illustrates a block diagram of an example computing device 102, in accordance with certain embodiments of the present disclosure. Computing device 102 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, computing device 102 may be a personal computer, a network storage device, or any other suitable device and may vary in size, shape, performance, functionality, and price. In certain embodiments, computing device 102 may be a personal computer or a workstation (e.g., a desktop computer or a portable computer). In other embodiments, computing device 102 may include a server. As depicted in FIG. 1, computing device 102 may comprise a processor 103 and a memory 104 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored and/or communicated memory 104.

Memory 104 may be communicatively coupled to processor 103 and may comprise any system, device, or apparatus configured to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, solid state storage, or any suitable selection and/or array of volatile or non-volatile memory that retains data after power to computing device 102 is turned off. As shown in FIG. 1, memory 104 may have stored thereon hardware description language (HDL) models 106, an HDL complier 108, and an HDL simulator 110.

HDL models 106 may include one or more formal descriptions of electronic circuits, describing operation, design, and/or organization of such circuits. HDL models 106 may also include tests to verify circuit operations by means of simulation and/or assertions regarding one or more circuits described in HDL models 106. HDL models 106 may be written in any suitable HDL, including without limitation VHDL, Verilog, SystemVerilog, and SystemC.

HDL compiler 108 may include a program of instructions configured to, when executed by processor 103, transform HDL models 106 written in an HDL into another language (e.g., object code) to create HDL simulator 110. HDL simulator 110 may include a program of instructions configured to, when executed by processor 103, perform simulations to simulate operation and/or verify design of circuits described in HDL models 106. In some embodiments, HDL simulator 110 may comprise independently-executable code. In other embodiments, HDL simulator 110 may require another executable program to execute the code of HDL simulator 110. In accordance with the present disclosure, HDL compiler 108 may be configured to compile HDL models 106 using assertions-based scheduling, as described in greater detail below.

FIG. 2 illustrates a flow chart of an example event-driven HDL simulation flow 200, in accordance with certain embodiments of the present disclosure. As shown in FIG. 2, an event queue 202 may include one or more events to simulated. In a time-step phase 204, events that are scheduled for a current time are removed from event queue 202 and executed, as indicated by steps 206 and 208. Following time-step phase 204, evaluation phase 210 may include activating processes sensitive to events occurring at the current time (step 212), and updating event queue 202 to include new events based on such activated processes (step 214). The time-step phase/evaluation phase loop may continued until there are no more events pending for the current time, after which the simulation time may be advanced to the time of the next pending event on the front of event queue 202. Simulation flow may continue until event queue 202 is empty.

During process activation in a given simulation cycle (step 212), multiple processes may need to be activated. The order in which these processes are activated in a given simulation cycle may have no bearing on the accuracy of the simulation results, but may have an impact on performance of a simulator (e.g., HDL simulator 110). Thus, simulation performance may be increased if processes are activated in an optimal order.

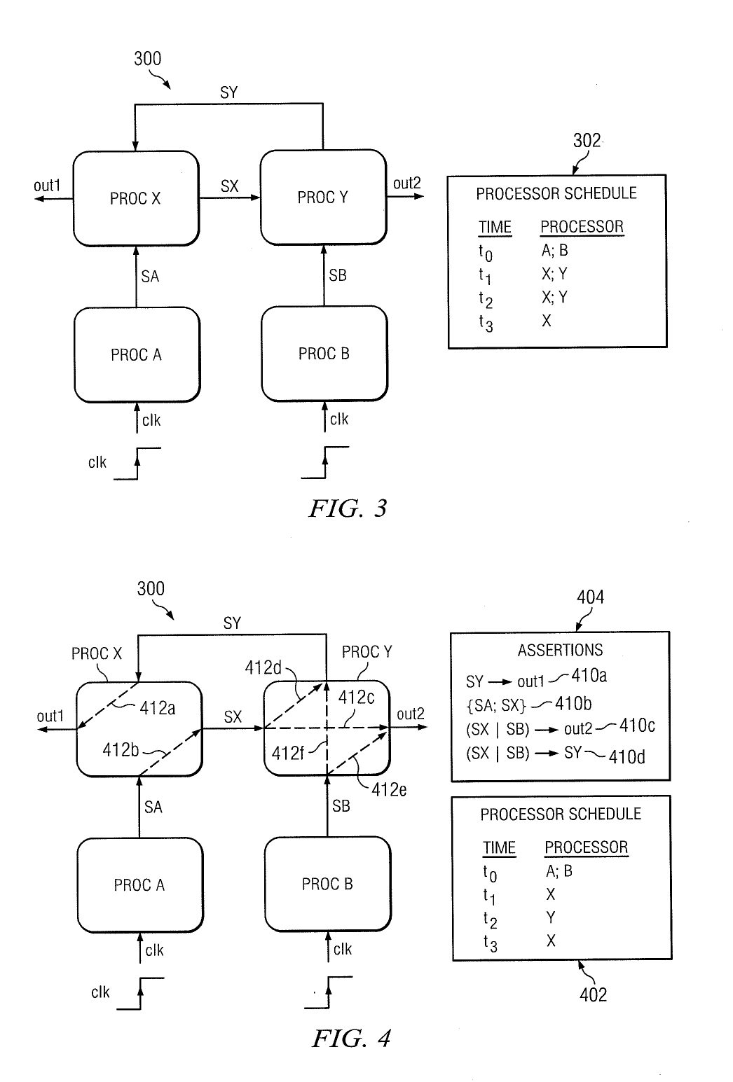

To illustrate, reference is made to FIG. 3. FIG. 3 illustrates a block diagram of processes modeled by a hardware description language and a process schedule based on relationships among such processes, in accordance with certain embodiments of the present disclosure. Notably, the process schedule 302 depicted in FIG. 3 is not assertion-based. As shown in FIG. 3, an example process set 300 may include processes A, B, X and Y. In the example of FIG. 3, process A is dependent upon a clock signal CLK and produces an event SA. Process B is dependent upon the clock signal CLK and produces an event SB. Process X is dependent upon event SA and an event SY and produces an event out1 and an event SX. Process Y is dependent upon event SB and event SX and produces an output out2 and an event SY. Processes A, B, X and Y and the relationships among them may be modeled in HDL models 106. Based upon the model of these processes and their relationships process schedule 302 may during simulation, dynamically schedule a time for which each process may be evaluated during simulation based on such events. Processes A and B may be evaluated at time t₀, processes X and Y may be evaluated at the next time interval time t₁, processes X and Y may both be evaluated again at the next time interval time t₂, and process X may be evaluated at the subsequent time interval time t₃.

However, as suggested above, HDL compiler 108 may be configured to create a process schedule based on assertions set forth in HDL models 106. During compilation of HDL models 106, HDL compiler 108 may transform HDL models 106 into an HDL simulator 110 configured to assume assertions are true, create a dependency graph based on such assertions, and dynamically schedule simulation processes based on dependency graphs, as shown in FIGS. 4 and 5. FIG. 4 illustrates a block diagram of processes modeled by a hardware description language and a process schedule based on relationships among the processes and created using assertions-based scheduling, in accordance with certain embodiments of the present disclosure. FIG. 5 illustrates a flow chart of an example method 500 for process scheduling using assertions-based scheduling, in accordance with certain embodiments of the present disclosure.

As shown in FIG. 4, one or more assertions 404 may be applied to process set 300. Such assertions 404 may in some embodiments be included within HDL models 106. Example assertions 404 depicted in FIG. 4 are set forth in Property Description Language (PSL). In the example assertions 404 depicted in FIG. 4, assertion 410a states that event SY implies event out1 (e.g., if event SY is true, then out1 is true). Assertion 410b states that event SX depends on event SA (e.g., SA will always occur before SX). Assertion 410c states that event SX or event SB implies event out2 (e.g., if either event SX or SB is true, then out2 is true). Assertion 410d states that event SX or event SB implies event SY (e.g., if either event SX or SB is true, then SY is true).

As depicted in step 502 of FIG. 5, HDL models 106 may be complied by

HDL compiler 108 to create an HDL simulator 110 configured to assume that assertions 404 are true. As shown by step 504, HDL simulator 110 may be configured to create a dependency graph representing the dependencies of certain events upon other events. For example, dotted line arrows 412a-412f may represent directed edges of such a dependency graph for the processes of process set 300 based on assertions 404. As shown by dotted line arrows/directed edges 412a-412f: (a) event out1 is dependent on event SY (directed edge 412a, based on assertion 410a), (b) event SX is dependent on event SA (directed edge 412b, based on assertion 410b), (c) event out2 is dependent on event SX and event SB (directed edges 412c and 412e, based on assertion 410c), and (d) event SY is dependent on event SX and event SB (directed edges 412d and 412f, based on assertion 410d).

As shown by step 506, HDL simulator 110 may be configured to dynamically schedule processes for simulation based on the dependency graph represented by directed edges 412a-412f. Such dynamic scheduling may result in process schedule 402 depicted in FIG. 4. Such dynamic, assertion-based scheduling may provide that processes A and B may be evaluated at time t₀, process X may be evaluated at the next time interval time t₁, process Y may be evaluated at the next time interval time t₂, and process X may be evaluated at the subsequent time interval time t₃. Comparing process schedule to 402 to process schedule 302, assertion-based scheduling eliminates process Y from time t₁ and process X from time t₂. Accordingly, simulation of process set 300 may execute faster and/or may require fewer computing resources using assertion-based scheduling.

A component of computing device 102 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer (e.g., computing device 102). Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage media. Examples of memory include computer memory (for example, Random Access Memory (RAM) or Read Only Memory (ROM)), mass storage media (for example, a hard disk), removable storage media (for example, a Compact Disk (CD) or a Digital Versatile Disk (DVD)), database and/or network storage (for example, a server), and/or other computer-readable medium.

Modifications, additions, or omissions may be made to computing device 102 without departing from the scope of the invention. The components of computing device 102 may be integrated or separated. Moreover, the operations of system 100 may be performed by more, fewer, or other components. Additionally, operations of computing device 102 may be performed using any suitable logic. As used in this document, “each” refers to each member of a set or each member of a subset of a set.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. An article of manufacture comprising:
a memory; and
computer-executable instructions carried on the memory, the instructions executable by one or more processors and configured to cause the one or more processors to transform hardware description language models of one or more hardware circuits into a program of instructions configured to simulate the one or more hardware circuits, the program of instructions further configured to, when executed:
assume assertions regarding the hardware description language models are true;
establish dependencies among processes of the program of instructions based on the assertions; and
dynamically schedule execution of the processes based on the established dependencies.

2. An article of manufacture according to claim 1, wherein the assertions are set forth in the hardware description language models.

3. An article of manufacture according to claim 1, wherein the assertions are set forth in Property Description Language.

4. An article of manufacture according to claim 1, wherein the dependencies are set forth in a dependency graph.

5. A computing device comprising:
a processor; and
a memory communicatively coupled to the processor and having stored thereon instructions executable by the processor and configured to cause the processor to transform hardware description language models of one or more hardware circuits into a program of instructions configured to simulate the one or more hardware circuits, the program of instructions further configured to, when executed:
assume assertions regarding the hardware description language models are true;
establish dependencies among processes of the program of instructions based on the assertions; and
dynamically schedule execution of the processes based on the established dependencies.

6. A computing device according to claim 5, wherein the assertions are set forth in the hardware description language models.

7. A computing device according to claim 5, wherein the assertions are set forth in Property Description Language.

8. A computing device according to claim 5, wherein the dependencies are set forth in a dependency graph.

9. A method comprising:
reading hardware description models of one or more hardware circuits;
transforming the hardware description language models into a program of instructions configured to, when executed by a processor:
assume assertions regarding the hardware description language models are true;
establish dependencies among processes of the program of instructions based on the assertions; and
dynamically schedule execution of the processes based on the established dependencies.

10. A method according to claim 9, wherein the assertions are set forth in the hardware description language models.

11. A method according to claim 9, wherein the assertions are set forth in Property Description Language.

12. A method according to claim 9, wherein the dependencies are set forth in a dependency graph.
